(19) United States
(12) Patent Application Publication
(10) Pub. No.: US 2026/0009409 A1
(43) Pub. Date: Jan. 8, 2026

(54) CYLINDER ASSEMBLY FOR TILTING A VACUUM TANK

(71) Applicant: The Charles Machine Works, Inc., Perry, OK (US)

(72) Inventors: Lance D. Littlewood, Edmond, OK (US); Levi J. Krutzfeldt, Perry, OK (US)

(21) Appl. No.: 19/330,049

(22) Filed: Sep. 16, 2025

Related U.S. Application Data
(63) Continuation of application No. 18/304,060, filed on Apr. 20, 2023, now Pat. No. 12,435,741.
(60) Provisional application No. 63/332,765, filed on Apr. 20, 2022.

(51) Int. Cl. F15B 15/14; F15B 1/26

(52) U.S. Cl. CPC F15B 15/1428; F15B 1/26

(57) ABSTRACT

A dual-cylinder tilting assembly for use with a vacuum tank. The tank is mounted on a frame, such as a trailer or a truck bed, at a pivotal connection at its end. A door is disposed near the end with the pivotal connection. The tilting assembly is at the other end, and has two cylinders with their rods facing alternate directions. The rod of one of the cylinders is pivotally attached to the frame and the rod of the other is pivotally attached to the tank. The barrels of the two cylinders are joined physically and hydraulically linked. The cylinder assembly, when fully extended, extends approximately three times its unextended length and tilts the tank at an angle of thirty to fifty degrees.

### SUMMARY

The present invention is directed to a vacuum system. The vacuum system comprises a tank, a frame, and a cylinder assembly. The tank extends from a first end to a second end. The tank comprises a door disposed at the second end and a mount disposed at the first end. The frame is supported by a plurality of ground supporting members. The tank is supported on the frame. The cylinder assembly comprises a first cylinder and a second cylinder. The first cylinder comprises a first barrel and a first rod. The second cylinder comprises a second barrel and a second rod. The first cylinder is attached to the frame at a first connection point. The second cylinder is attached to the mount at a second connection point. The first barrel and second barrel are joined together.

In another aspect the invention is directed to a cylinder assembly. The cylinder assembly comprises a first cylinder, a second cylinder, and a hydraulic supply. The first cylinder comprises a first barrel and a first rod, where the first rod is extendable from the first barrel in a first direction. The second cylinder comprises a second barrel and a second rod. The second rod is extendable from the second barrel in a second direction. The second direction is opposite from the first direction. The hydraulic supply is in fluid communication with each of the first barrel and the second barrel. The first barrel and the second barrel are fixed in position relative to each other by a brace.

### BRIEF DESCRIPTION OF THE DRAWINGS

FIG. 1 is a side view of a vacuum tank assembly disposed on a trailer with a tilt cylinder in its retracted position.

FIG. 2 is a top right front perspective view thereof.

FIG. 3 is the view of FIG. 2 with components of the vacuum system external from the tank removed so that the tilt cylinder is visible.

FIG. 4 is a side view of the vacuum tank assembly disposed on a trailer with a tilt cylinder in its fully extended position.

FIG. 5 is a left front top perspective view thereof.

FIG. 6 is a left back top perspective view thereof.

FIG. 7 is detail D of FIG. 6.

FIG. 8A is a side view of the vacuum tank assembly with a dashed line representing a plane disposed through a connection point between a cylinder assembly and the trailer. The connection point between the tank mount and the cylinder assembly is on a first side of the plane.

FIG. 8B is a side view of the vacuum tank assembly of FIG. 8A with the cylinder extended. The connection point between the tank mount and the cylinder assembly is on a second side of the plane.

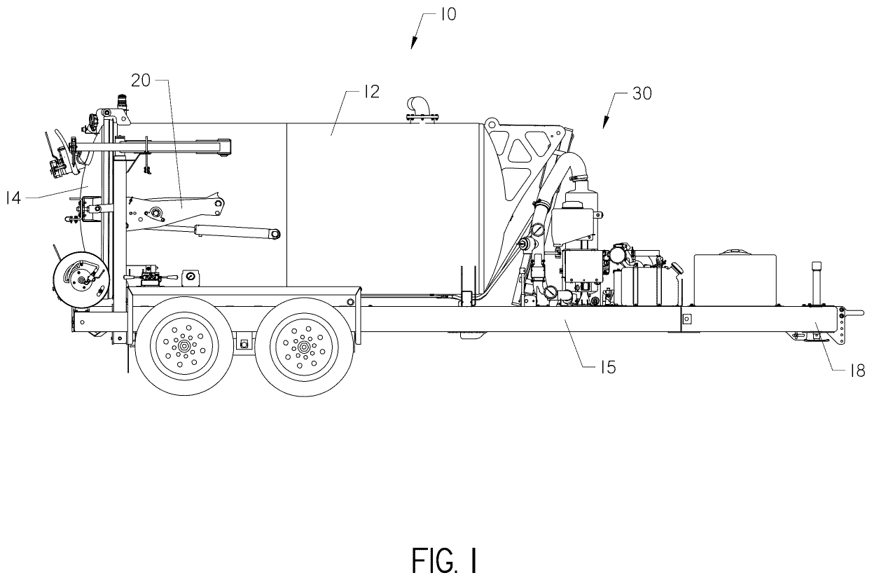

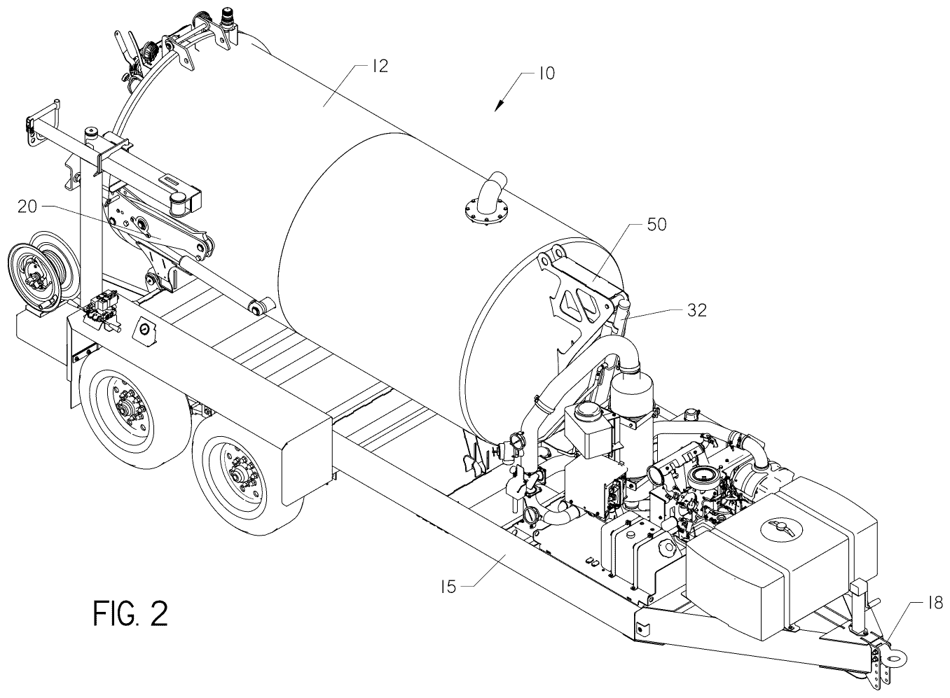

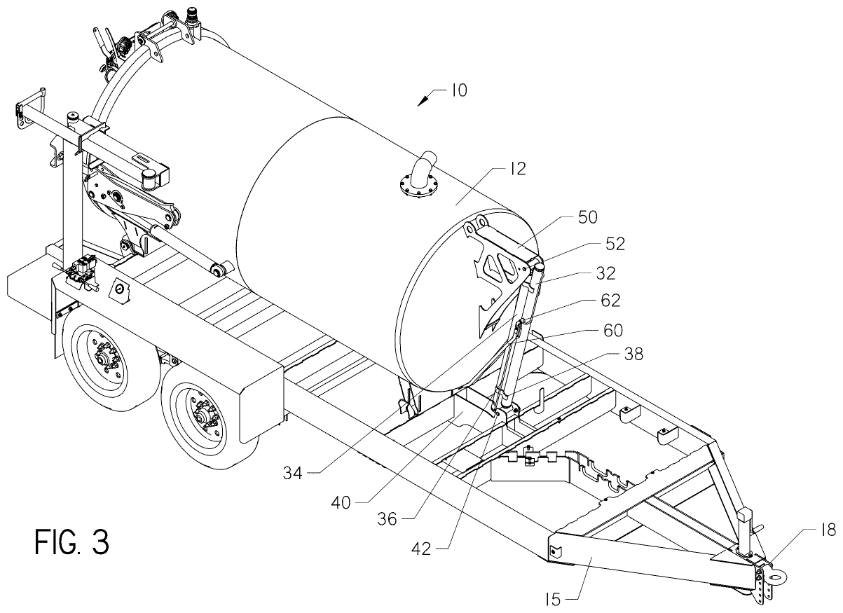

### DETAILED DESCRIPTION

Vacuum tanks are used in underground construction applications to remove material from an excavation. Often fluid is used to lubricate a drill bit during drilling operations. Fluid then migrates up a borehole into a pit. In other applications, fluid such as air or water is used to dislodge soil from around a buried utility. The dislodged soil must then be removed to fully uncover the utility. A vacuum system allows this fluid to be removed and, in some circumstances, reused, reducing the environmental footprint associated with underground construction operations.

Material which is removed to a vacuum tank, however, is often quite viscous. Drilling mud and mud material may be difficult to remove from the body of a vacuum tank, slowing operations and limiting the ability to quickly empty the tank for continued use.

The tilt angle of a vacuum tank is limited by the stroke of its cylinder. In traditional vacuum tanks, one or two tilt cylinders are provided on a trailer assembly, and extend to tilt the cylinder, allowing gravity to excavate the cylinder. Given the viscosity of the material involved, providing a longer stroke without increasing the profile of the vacuum system or sacrificing strength is quite important.

Turning now to the figures, a trailer mounted vacuum system 10 is shown therein. The vacuum system includes a tank 12. The tank 12 has a door 14 disposed at one end. The tank 12 is supported by a trailer 15 with one or more ground support members 16, such as wheels. As shown, the trailer 15 has four wheels disposed proximate the door 14. A hitch 18 or other connection is disposed at the other end of the trailer.

The door 14 of the tank 12 is opened and closed by a hydraulic closure assembly 20. Different assemblies are known in the art. Shown in the figures is an assembly 20 disclosed in U.S. Pat. No. 10,221,602, issued to Sewell, the contents of which are incorporated herein by reference.

In traditional operations, tanks 12 mounted on trailers 15 are tilted by individual cylinders mounted on the side of the tank, or a single telescoping cylinder on the front of the tank. The mechanical advantage is the greatest when lifting from the front of the tank, but the stroke is often greater, as the cylinder barrel is already upright. Lifting along the side of the tank may allow a shorter stroke, but reduces mechanical advantage and requires more robust cylinders.

As shown in the figures, in the present invention, a piggyback cylinder assembly 30 is mounted on the front of the tank between a trailer mount 40 and a tank mount 50. The piggyback cylinder assembly 30 provides a lifting mechanism which uses two hydraulically connected cylinders 32, 34. The assembly 30 provides advantages of lifting from the front of the tank 12 while controlling cost, complexity, and allowing for a large tilt angle. As the cylinder assembly 30 extends, the tank 12 is caused to pivot about a tank pivot connection 35.

The cylinder assembly 30 comprises a first cylinder 32 and a second cylinder 34. The first cylinder 32 and second cylinder 34 are connected by a hydraulic conduit 36 which equalizes the pressure within each cylinder 32, 34. Thus, when hydraulic fluid is provided to the assembly 30, both cylinders are pressurized, causing rods to extend from each cylinder 32, 34. The rod of the first cylinder 32 is oriented in the opposite direction as the rod of the second cylinder 34. In this way, the extended length of the cylinder assembly 30 is approximately three times the retracted length of the cylinder assembly, subject to the small differences between the rod length and unextended cylinder length and offsets between the cylinders 32, 34.

The cylinders 32, 34 are joined together at one or more braces 38. The cylinders 32, 34 may be welded at the braces 38. Hydraulic supply lines 60 extend from a bottom side of the tank 12 to ports 62. Preferably, the ports 62 are closer to the tank 12 when extended than when retracted. In this way, the hydraulic supply lines 60 may be kept away from moving portions of the assembly 30 and excess slack in the lines 60 exists only when extended and the lines are far from pinch points on the assembly 30.

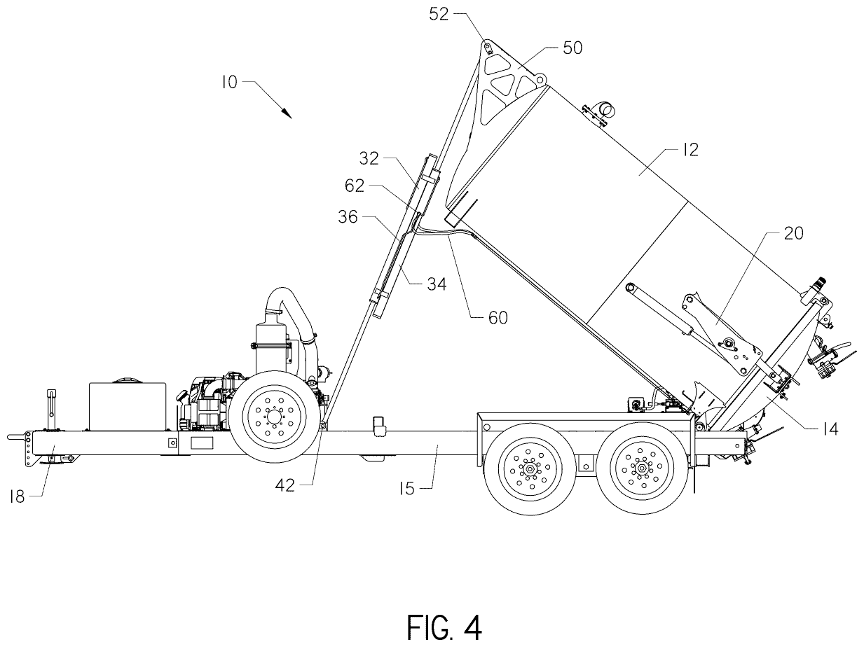

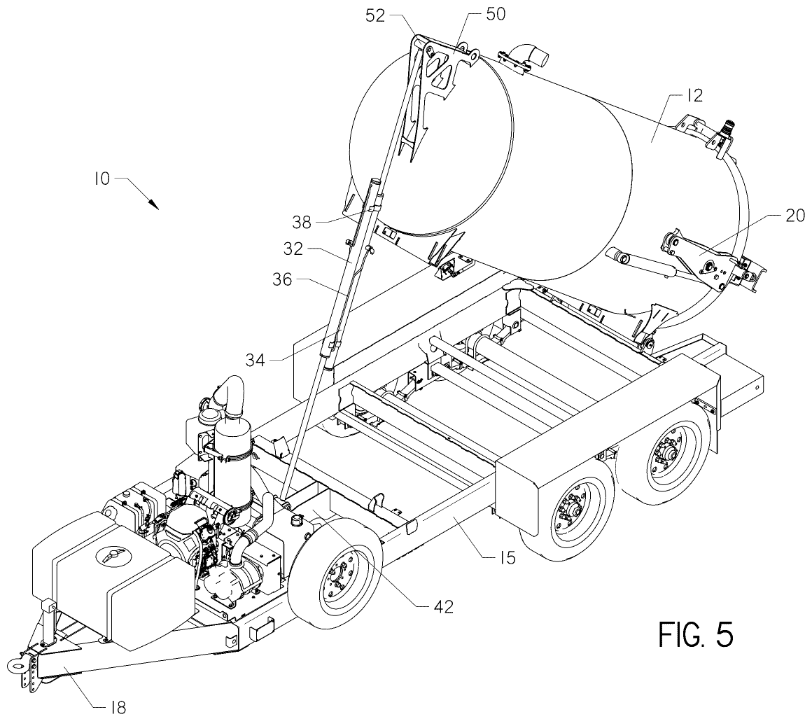

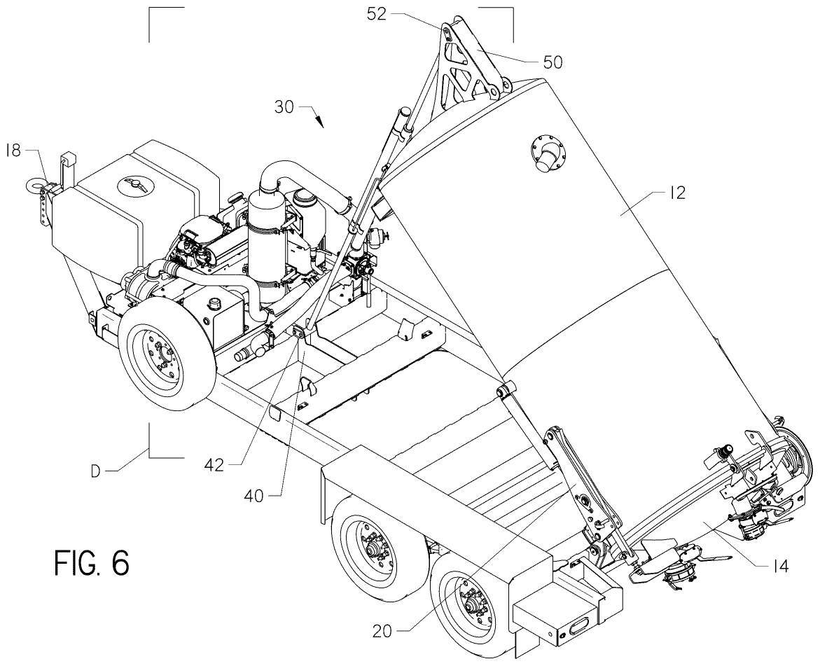

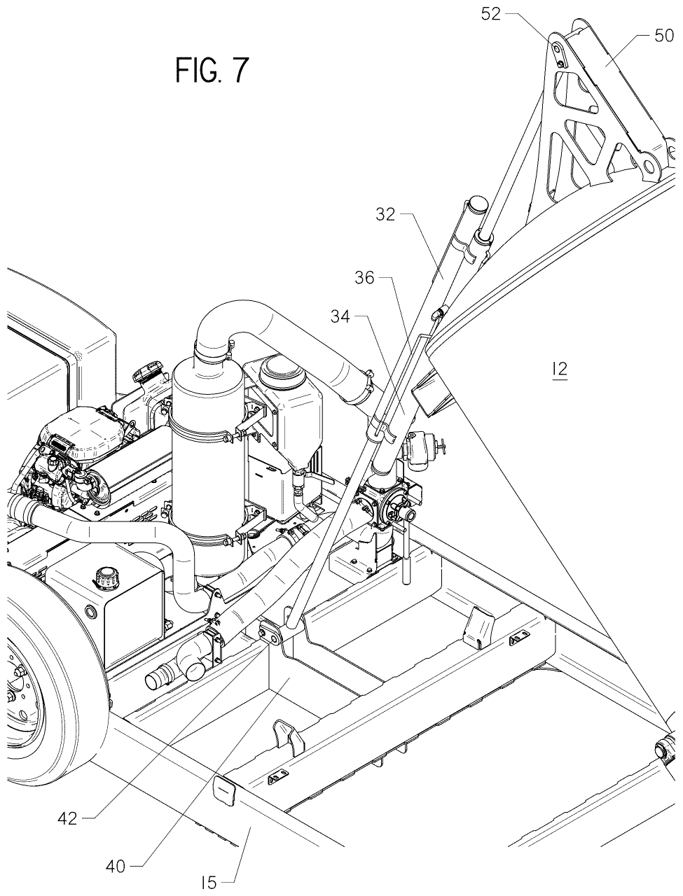

The cylinders 32, 34 are sized such that the tank 12 is flat on the trailer 15 when fully retracted, and at a significant angle (measured at the tank pivot point 35) when fully extended, as shown in FIGS. 4-7. The angle may be between thirty and fifty degrees from horizontal. As shown, the system is engineered for a fully-extended forty degree angle.

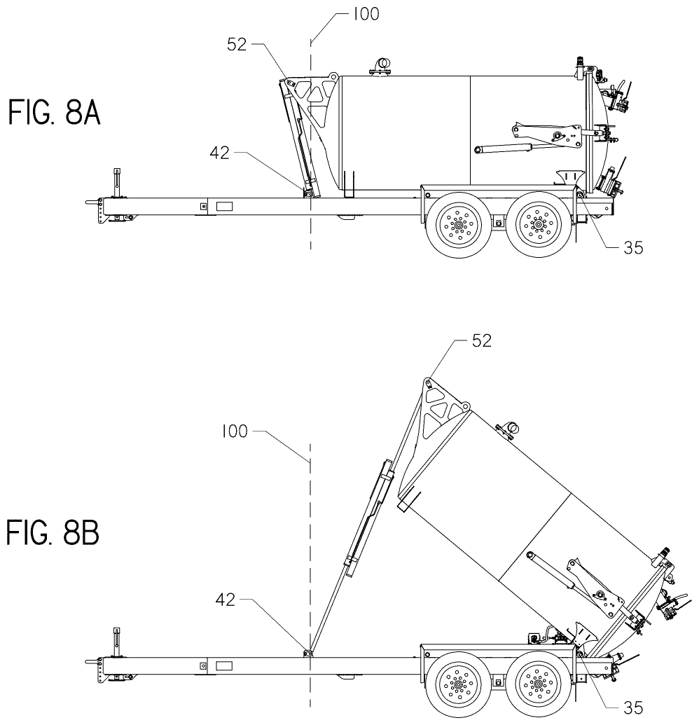

The tank mount 50 extends forward and away from the tank 12. As shown, a connection point 52 on the tank mount 50 is further away from the tank than a connection point 42 on the trailer mount 40. As the cylinder assembly 30 extends, connection point 52 passes through and across a vertical plane 100 extending through the connection point 42. When the cylinder assembly 30 is retracted, the connection point 52 is on an opposite side of the plane 100 from the tank 12. When the cylinder assembly 30 is extended, the connection point 52 and tank 12 are on the same side of the plane 100. This arrangement is demonstrated by FIGS. 8A and 8B, where the extension of the cylinder assembly 30 causes the connection point 52 to cross over the plane 100.

In other words, the connection point 52 is closer, in horizontal distance, to the tank pivot point 35 than the connection point 42 when the cylinder assembly 30 is fully extended, and further from the tank pivot point 35, in horizontal distance, than the connection point 42 when the cylinder assembly 30 is retracted.

The trailer mount 40 comprises ears similar to a dump truck to allow the tank 12 to return to the same position even if on an incline.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A cylinder assembly comprising:
a first cylinder comprising a first barrel and a first rod extendable from the first barrel in a first direction;
a second cylinder comprising a second barrel and a second rod extendable from the second barrel in a second direction opposite the first direction;
wherein the first barrel and the second barrel are fixed relative to one another; and
wherein a fully extended length of the cylinder assembly is greater than twice a retracted length of the cylinder assembly.

2. The cylinder assembly of claim 1 in which the fully extended length of the cylinder assembly is approximately three times the retracted length of the cylinder assembly.

3. The cylinder assembly of claim 1 in which the first cylinder is hydraulically connected to the second cylinder.

4. The cylinder assembly of claim 1 further comprising a brace joining the first barrel and the second barrel.

5. The cylinder assembly of claim 1 in which the cylinder assembly is configured to tilt a tank body relative to a frame as the first rod and the second rod extend, wherein the cylinder assembly comprises a hydraulic port, wherein the hydraulic port is closer to the tank body when the rods are fully extended than when the rods are fully retracted.

6. The cylinder assembly of claim 5, wherein the first rod is pivotally connectable to the frame at a first connection point and the second rod is pivotally connectable to the tank body at a second connection point, and wherein the second connection point crosses a vertical plane passing through the first connection point as the cylinder assembly extends from a fully retracted condition to a fully extended condition.

7. The cylinder assembly of claim 5, further comprising hydraulic supply lines connected at one end to the hydraulic port and are attached to a bottom side of the tank body.

8. A method of tilting a vacuum tank relative to a frame using the cylinder assembly of claim 1, the method comprising:
supplying pressurized hydraulic fluid to the first cylinder and the second cylinder; and
extending the first rod and the second rod, thereby rotating the vacuum tank relative to the frame while a second connection point between the cylinder assembly and the vacuum tank crosses a vertical plane passing through a first connection point between the cylinder assembly and the frame.

9. A vacuum system comprising:
a frame;
a tank supported by the frame and pivotally attached thereto at a pivot point; and
a cylinder assembly comprising:
a first cylinder having a first barrel and a first rod pivotally connected to the frame at a first connection point; and
a second cylinder having a second barrel and a second rod pivotally connected to the tank at a second connection point,
wherein the first barrel and the second barrel are fixed relative to each other; and
wherein the second connection point crosses a vertical plane passing through the first connection point when the cylinder assembly extends from a retracted condition to an extended condition.

10. The vacuum system of claim 9, wherein the second connection point is farther, in horizontal distance, from the pivot point than the first connection point when the rods are fully retracted, and is closer, in horizontal distance, to the pivot point than the first connection point when the rods are fully extended.

11. The vacuum system of claim 9, wherein the cylinder assembly further comprises a hydraulic supply in fluid communication with each of the first barrel and the second barrel.

12. The vacuum system of claim 9 in which the frame comprises a trailer.

13. The vacuum system of claim 9 in which the frame is disposed on a truck.

14. The vacuum system of claim 9, wherein the tank is rotatable to about forty degrees relative to the frame when the cylinder assembly is in the extended condition.

15. A vacuum system, comprising:
a frame;
a tank supported by the frame and pivotally attached thereto at a pivot point, the tank configured to receive spoils; and
a cylinder assembly connected at a single pivot point to the frame and connected at a single pivot point to the tank, the cylinder assembly comprising:
a first rod extendable in a first direction; and
a second rod extendable in a second direction;
such that extension of the first rod and the second rod causes the tank to tilt relative to the frame.

16. The vacuum system of claim 15 in which the first and second direction are opposite.

17. The vacuum system of claim 15 in which the tank is tilted between thirty and fifty degrees from horizontal when the first rod and the second rod are fully extended.

18. The vacuum system of claim 15 in which the tank comprises:
a tank body; and
a tank mount extending from the tank body, in which the single pivot point at which the cylinder assembly and the tank are connected is on the tank mount.

19. The vacuum system of claim 15 in which the cylinder assembly further comprises:
a first barrel from which the first rod is extendable;
a second barrel from which the second rod is extendable; and
a brace connecting the first barrel and the second barrel.

20. The vacuum system of claim 15 in which the cylinder assembly is tilted away from the tank when the first rod and the second rod are fully retracted, and in which the cylinder assembly is tilted toward the tank when the first rod and the second rod are fully extended.
